(19) United States
(12) Patent Application Publication
(10) Pub. No.: US 2016/0363704 A1
(43) Pub. Date: Dec. 15, 2016

(54) OPTICAL DEVICES, AND THEIR USE FOR SECURITY AND AUTHENTICATION

(71) Applicant: Nanotech Security Corp., Burnaby (CA)

(72) Inventors: Denis Gerard Vendette, Embrun (CA); Charles Douglas MacPherson, Santa Barbara, CA (US)

(21) Appl. No.: 15/177,904

(22) Filed: Jun. 9, 2016

Related U.S. Application Data
(60) Provisional application No. 62/173,628, filed on Jun. 10, 2015.

(30) Foreign Application Priority Data
Jun. 3, 2016 (CA) 2932080

(51) Int. Cl. G02B 5/28

(52) U.S. Cl. CPC G02B 5/285; G02B 5/283

(57) ABSTRACT

Disclosed herein are optical devices, suitable for use as authentication devices for security items and documents including banknotes. The devices are generally static and yet in some embodiments have perceived dynamic optical properties due to their apparent capacity to cause output luminescent radiation to “flash” as the devices are progressively tilted relative to a user or detector of the emitted luminescent radiation. Also disclosed are items and documents comprising such devices, methods for manufacture and use of the devices, and authentication devices suitable to check whether the disclosed authentication device are legitimate or counterfeit.

This application claims priority to Canadian Patent Application filed Jun. 3, 2016 and U.S. Provisional Patent Application No. 62/173,628 filed Jun. 10, 2015; all of which are incorporated by reference herein in their entirety.

### FIELD OF THE INVENTION

This invention relates to the field of optical devices, in particular optical devices the perceivable or detectable appearance of which changes according to the orientation of the device. The invention also relates to the field of optical devices for authentication of security items and documents, including but not limited to banknotes.

### BACKGROUND TO THE INVENTION

Optical devices that are difficult to manufacture, replicate or reverse-engineer, play a key role in anti-counterfeit efforts. Such devices may be affixed to or incorporated into items or documents of importance or value, thus enabling a user to check for authenticity by study or analysis of observable or detectable optical features of the device. Typically, such devices comprise layered or multi-layered structures where user manipulation of the device, or a user-initiated external influence upon the device, causes a change in appearance of the device, or at least a portion thereof. The change in appearance may result from some physical or chemical change that occurs upon user manipulation of the device. Alternatively, there may be no physical or chemical change upon user manipulation of the device. Instead, the apparent change in appearance may only comprise a change in a user's perception of the device, for example when viewed at different angles or under different ambient or incident light conditions.

Often, such optical devices are planar and thin (e.g. thin films), such that when applied to a substrate they appear flush with the substrate without protruding significantly from the substrate. In the case where the optical devices are applied to a flexible substrate such as plastic or paper, the devices themselves may also be flexible or foldable such that they conform to the contours of the substrate during use.

In the ‘fight’ against counterfeiting, there remains a constant need in the art to develop new optical devices that are readily perceivable or detectable to a user or consumer, but which exhibit optical properties that are conspicuous yet difficult to replicate. The need extends to optical devices with both relatively simple content, and also to devices with more complex content, including devices that are single use or that can repeatedly undergo a perceived change in optical or physical characteristics. Ideally, though not necessarily, there is a need for such devices that can be manufactured in a relatively simple and inexpensive manner. The need for such devices extends into multiple disciplines, including but not limited to interactive media material, advertisements, magazines, books or other items with user-manipulated content, advertising billboards, and authentication devices for security documents such as passports, credit cards and banknotes to help prevent counterfeit.

### SUMMARY

It is an object of selected embodiments to provide an optical device with optical properties that are characteristic of the device, which can be observed or detected by a user.

It is a further object of selected embodiments to provide an item or document, such as a security item or document, comprising an optical device as described herein attached to or otherwise incorporated into the device.

The following embodiments are exemplary:

In exemplary embodiment 1 there is provided an optical device comprising:
a. a luminescent material that upon stimulation emits luminescent radiation of at least one peak output wavelength; and
b. an angle-dependent optical filter coupled to the luminescent material, the luminescent radiation transmitted through and emitted from the filter in an angle dependent manner, such that inspection whilst progressively tilting the device (e.g. through 45 degrees) causes at least one colour or fraction of the luminescent radiation emanating from the device to be observable or detectable external to the device.

In exemplary embodiment 2 there is provided the optical device of embodiment 1, wherein the optical filter coupled to the luminescent material selectively emits the luminescent radiation from the device at one or more peak output angles, with at least 70% of the luminescent radiation produced by the luminescent material emitted from the device at, or within 15 degrees from, the one or more peak output angles.

In exemplary embodiment 3 there is provided the optical device of embodiment 2, wherein the optical filter causes at least 80% of the luminescent radiation to be emitted at, or within 10 degrees from, two or more peak output angles, with fractions of the luminescent radiation emitted from the device momentarily observable or detectable at different output angles as the device is progressively tilted.

In exemplary embodiment 4 there is provided the optical device of embodiment 2, wherein the optical filter causes at least 90% of the luminescent radiation to be emitted at, or within 5 degrees from, three or more peak output angles, with three or more fractions of the luminescent radiation emitted from the device momentarily observable or detectable at different output angles as the device is progressively tilted.

In exemplary embodiment 5 there is provided the optical device of embodiment 1, wherein the luminescent material emits a luminescent radiation with a full wave half maximum (FWHM) of 50 nm or less.

In exemplary embodiment 6 there is provided the optical device of embodiment 1, wherein the luminescent material emits a luminescent radiation with a full wave half maximum (FWHM) of 25 nm or less.

In exemplary embodiment 7 there is provided the optical device of embodiment 1, wherein the luminescent material emits a luminescent radiation with a full wave half maximum (FWHM) of 10 nm or less.

In exemplary embodiment 8 there is provided the optical device of embodiment 1, wherein the luminescent material is stimulated to produce luminescent radiation by incident ultraviolet light.

In exemplary embodiment 9 there is provided the optical device of embodiment 1, wherein the optical filter comprises an optical interference structure, such as a Fabry Perot structure, a Bragg stack, or thin-film filter or foil.

In exemplary embodiment 10 there is provided the optical device of embodiment 1, wherein the luminescent material and the optical filter are matched in terms of the specificity of the optical filter to filter radiation of a wavelength corresponding to the at least one peak output wavelength of the luminescent radiation, in an angle-dependent manner.

In exemplary embodiment 11 there is provided the optical device of embodiment 1, wherein the luminescent material, when stimulated, produces luminescent radiation of more than one peak output wavelength for angle-dependent filtering by the optical filter, the luminescent radiation of one wavelength emitted from the device at one or more peak output angles that are the same or different from the peak output angles of luminescent radiation of at least one other wavelength, with different fractions of the luminescent radiation emitted from the device with different colours or wavelengths momentarily and separably observable or detectable as the device is progressively tilted.

In exemplary embodiment 12 there is provided the optical device of embodiment 1, wherein the device comprises more than one type of luminescent material, each producing when stimulated luminescent radiation of a peak output wavelength that is different to the other types of luminescent material(s) present, so that the device produces luminescent radiation of more than one peak output wavelength, for angle-dependent filtering by the optical filter, the luminescent radiation of one wavelength emitted from the device at one or more peak output angles that are the same or different from the peak output angles of luminescent radiation of at least one other wavelength, with different fractions of the luminescent radiation emitted from the device with different colours or wavelengths momentarily and separably observable or detectable as the device is progressively tilted.

In exemplary embodiment 13 there is provided a use of an optical device of any one of embodiments 1 to 12, to provide authentication to a security item or document.

In exemplary embodiment 14 there is provided the use of embodiment 13, wherein the security document is a banknote.

In exemplary embodiment 15 there is provided a security item, security card or security document, comprising a substrate with the optical device of any one of embodiments 1 to 12 affixed or adhered thereto.

In exemplary embodiment 16 there is provided the security item, security card or security document of embodiment 15, which is a banknote.

In exemplary embodiment 17 there is provided a method for determining whether a security item, security card or security document is a legitimate or counterfeit item, card or document, the item, card or document comprising an optical device of any one of embodiments 1 to 12, the method comprising the steps of: illuminating the optical device with radiation of a wavelength suitable to stimulate the luminescent material or materials present; progressively tilting the item, card or document whilst the device emits luminescent radiation; and observing or detecting at least one fraction of said luminescent radiation emitted from the device.

In exemplary embodiment 18 there is provided the method of embodiment 17, wherein a predetermined spatial pattern of detected or observed fractions of luminescent radiation as the device is progressively tilted is indicative that the device is legitimate and not counterfeit.

In exemplary embodiment 19 there is provided a method for improving the security of a security item, security card or security document, to help prevent counterfeit thereof, the method comprising: adhering or affixing an optical device of any one of embodiments 1 to 12 to the item, card or document.

In exemplary embodiment 20 there is provided method of embodiment 19, wherein the item, card or document is a banknote.

In exemplary embodiment 21 there is provided the method of any one of embodiments 17 to 20 wherein the step of tilting is performed by a human or a machine.

In exemplary embodiment 22 there is provided a method for determining whether a security item, security card or security document is a legitimate or counterfeit item, card or document, the item, card or document comprising an optical device as described herein, the method comprising the steps of: illuminating the optical device with radiation of a wavelength suitable to stimulate the luminescent material or materials present; positioning a plurality of sensors at a plurality of positions or angles relative to the optical device whilst the optical device emits luminescent radiation; and detecting with said sensors at least one fraction of said luminescent radiation emitted from the optical device.

In exemplary embodiment 23 there is provided the method of exemplary embodiment 22, further comprising one or more of the following optional steps: calculating and optionally displaying the detected output angles for the luminescent radiation from the device, and optionally comparing the detected output angles with predetermined output angles known to correlate with legitimate optical devices.

In exemplary embodiment 24 there is provided an authentication device, to test whether a security item, security card or security document comprising an optical device of any one of embodiments 1 to 12 is legitimate or counterfeit, the authentication device comprising:
optionally a holder to hold the item, card or document being tested;
a source of electromagnetic radiation suitable to stimulate the luminescent material of the optical device; and
one or more sensors to gather information regarding angles of emission of luminescent radiation from the device;
optionally movement means to move the one or more sensors and the item or document relative to one another, to enable the one or more sensors to scan for different angles of emission of luminescent radiation from the device;
a comparison component to compare sensed angles of emission of luminescent radiation from the optical device with predetermined angles of emission known to be indicative of an authentic optical device, and therefore indicative an authentic item, card or document comprising the optical device.

In exemplary embodiment 25 there is provided the authentication device of embodiment 24, further comprising an output component to provide a visual or electronic signal indicative of whether the item, card or document comprising the optical device is authentic or counterfeit.

In exemplary embodiment 26 there is provided the authentication device of claim 24, wherein a plurality of sensors are present each to detect luminescent radiation emitted at a different emission angles from the device so that the plurality of sensors gather information regarding angles of emission of luminescent radiation from the device without need to move the sensors and the item or document relative to one another.

### BRIEF DESCRIPTION OF THE DRAWINGS

FIG. 1a provides a schematic cross-sectional view of an example optical device at an angle theta of 45 degrees between a user's line of sight and a plane of the substrate to which the device is applied.

FIG. 1b provides a schematic cross-sectional view of the same example optical device as illustrated in FIG. 1a, at an angle theta of 60 degrees between a user's line of sight and a plane of the substrate to which the device is applied.

FIG. 2a provides a graph to compare schematically both luminescent radiation intensity and optical filter transmission with wavelength, for the optical device as shown in FIG. 1a.

FIG. 2b provides a graph to compare schematically both luminescent radiation intensity and optical filter transmission with wavelength, for the optical device as shown in FIG. 1b.

FIG. 3a provides a schematic cross-sectional view of an example optical device at an angle theta of 45 degrees between a user's line of sight and a plane of the substrate to which the device is applied.

FIG. 3b provides a schematic cross-sectional view of the same example optical device as illustrated in FIG. 3a, at an angle theta of 60 degrees between a user's line of sight and a plane of the substrate to which the device is applied.

FIG. 4a provides a graph to compare schematically both luminescent radiation intensity and optical filter transmission with wavelength, for the optical device as shown in FIG. 3a.

FIG. 4b provides a graph to compare schematically both luminescent radiation intensity and optical filter transmission with wavelength, for the optical device as shown in FIG. 3b.

FIG. 5a provides a schematic cross-sectional view of an example optical device at an angle theta of 45 degrees between a user's line of sight and a plane of the substrate to which the device is applied.

FIG. 5b provides a schematic cross-sectional view of the same example optical device as illustrated in FIG. 5a, at an angle theta of 60 degrees between a user's line of sight and a plane of the substrate to which the device is applied.

FIG. 5c provides a schematic cross-sectional view of the same example optical device as illustrated in FIG. 5a, at an angle theta of 75 degrees between a user's line of sight and a plane of the substrate to which the device is applied.

FIG. 6a provides a graph to compare schematically both luminescent radiation intensity and optical filter transmission with wavelength, for the optical device as shown in FIG. 5a.

FIG. 6b provides a graph to compare schematically both luminescent radiation intensity and optical filter transmission with wavelength, for the optical device as shown in FIG. 5b.

FIG. 6c provides a graph to compare schematically both luminescent radiation intensity and optical filter transmission with wavelength, for the optical device as shown in FIG. 5c.

FIG. 7a illustrates the appearance of an example optical device at a first angle theta between a user's line of sight and a plane of the substrate to which the device is applied.

FIG. 7b illustrates the appearance of the same example optical device as that shown in FIG. 7a, at a second angle theta between a user's line of sight and a plane of the substrate to which the device is applied.

FIG. 7c illustrates the appearance of the same example optical device as that shown in FIG. 7a, at a third angle theta between a user's line of sight and a plane of the substrate to which the device is applied.

FIG. 8a provides a schematic cross-sectional view of an example optical device at an angle theta of 45 degrees between a user's line of sight and a plane of the substrate to which the device is applied.

FIG. 8b provides a graph to compare schematically both luminescent radiation intensity and optical filter transmission with wavelength, for the optical device as shown in FIG. 8b.

### DEFINITIONS

“Angle theta”: refers to the smallest angle between a line of sight of a user of a device as disclosed herein, and a plane of the substrate to which the device is attached, or the plane of the device itself.
“Flash”: refers to a brief or momentary detection of emitted electromagnetic radiation from a device as described herein. It will be understood that the devices disclosed herein do not actively flash on and off, because they are generally static in terms of their physical structure and function, and do not necessarily undergo a dynamic physical or chemical change. Thus the term “flash” refers to what may be perceived by a user of the device under stimulation by incident radiation, for example whilst the device is progressively tilted relative to the user (or detection device). In this way a narrow band of emitted luminescent radiation, continuously emitted at or near to a specific peak emission angle, is caused to pass across a line of sight of a user or detector, such that it at least appears from the user's perspective that a “flash” of luminescent radiation has been emitted from the device.
Item: refers to any object, document, substrate or material to which a device as described herein is applied, either permanently or temporarily. For example, in selected embodiments the item may be subject to counterfeit risks, such that the presence of an optical device as described herein affixed to or otherwise incorporated into the item may be indicative that the item is authentic or legitimate, and not counterfeit.
“Momentary”: refers typically to a time period of 3 seconds or less, 2 seconds or less, 1 second or less, 0.5 seconds or less, or 0.1 second or less. These time periods typically related to a “flash” of emitted luminescent radiation typically observed during progressive tilting of a device as disclosed herein relative to a user of the device at a constant rate for example of 10 degrees of tilt per second.
Optical properties: refers to the electromagnetic radiation reflected, transmitted, emitted or otherwise received from an optical device as herein described, that is visible to the naked eye of an observer, or is observable to an observer with the assistance of a screening or scanning tool. For example, where the optical properties of a device, or a change in such properties, are detectable only using incident UV or other beyond visible electromagnetic radiation, a corresponding screening tool may be one that emits UV radiation and directs the radiation onto the optical device under analysis. The optical properties of any device or element thereof as herein described may be caused, influenced or occur due to the material properties of the device, the degree of reflection, transmission, absorption, refraction or other modification of electromagnetic radiation incident thereupon, and may also depend upon the orientation, shape, structure, nanoscale properties, or other material properties of the device or element when taken alone or in combination with other devices, elements or device components.
“Peak output angle”: refers to an angle of emission for luminescent radiation being emitted from a device as disclosed herein in an angle-dependent manner due to the presence of an optical filter, and specifically the angle of the greatest intensity of emission compared to that of adjacent angles of emission. For any device, the optical filter may be such that multiple peak output angles may be present for a device, which may be the same or different in terms of their peak intensities.
“Peak output wavelength”: refers to the luminescent radiation emitted from luminescent material of a device as disclosed herein, and specifically to the wavelength of the radiation at the greatest intensity for the radiation.
Perceivable or detectable change (of optical properties of an optical device): refers to any change that occurs to a device as described herein, that may be perceived by the user of a device (through sight, touch etc.) or which is detected for example by a user of the device with the assistance of a screening tool. To provide just one example, a change of optical properties of a device might occur only in the beyond visible spectrum of electromagnetic radiation, in which case a user of the device may choose to employ a UV screening tool to detect a corresponding change in optical properties. For clarity, a perceivable or detectable change of optical properties of an optical device as disclosed herein does not necessarily result from a physical or chemical change in the device, but rather a perception (visual or detected) from a perspective of a user or detection apparatus.
Polymer core material: refers to any polymer or polymer-like substance suitable to form a substrate of an item or document. For example, the material may be in the form of a sheet-like configuration to be formed or cut into a size suitable for use in various items and documents. The polymer core material may be a substantially uniform sheet of polymer material, or may take the form of a laminate structure with layers or polymer film adhered together for structural integrity, such as disclosed for example in international patent publication WO83/00659 published Mar. 3, 1983, which is incorporated herein by reference. A polymer core material may also comprise a material that includes a polymer in combination with other materials such as plastic or paper to form a hybrid core material.
Reflected light: refers to light incident upon a surface and subsequently ‘bounced’ or otherwise reflected by that surface such that the reflected light is visible to the naked eye or detectable by a suitable means. The degree of light reflection may vary according to the surface, and the degree of light that is not reflected by the surface because it is scattered by, diffracted by, absorbed by, or transmitted through the surface and the material of the substrate.
Security document: refers to any document, item or article of manufacture of any importance or value, which is or might possibly be subject to or susceptible to counterfeit copying. In selected embodiments, a security document may include features or devices intended to show that the document, item or article is a genuine and legitimate version, and not a counterfeit copy of such a document, item or article. For example, such security documents may include security features such as those disclosed herein. Such security documents may include, but are not limited to, identification documents such as passports, citizenship or residency documents, drivers' licenses, banknotes, cheques, credit cards, bank cards, and other documents, as well as labeling or other security features, for items of monetary value such as designer clothing, accessories, or any other branded products where it is desired to indicate or demonstrate the authenticity or legitimacy of the product compared to a counterfeit copy. Such security features may be permanently or removably incorporated therein depending upon the nature of the document, item or article, and the intended end user.
Substrate/core material: refers to any material used to form the main substrate, structure or sheet of any item or document as described herein. In select embodiments, the material may be formed into a sheet or member, and may be composed of a substance selected from but not limited to paper, a plastic, a polymer, a resin, a fibrous material or the like, or combinations thereof. In selected embodiments the core material is of a material suitable for application thereto, either directly or indirectly, of an optically variable device of the types disclosed herein. The optically variable device, or elements thereof, may be applied or attached to the core material in any manner including the use of adhesive materials or layers, such as glues, or by overlaying an adhesive substance, film, varnish or other material over the top of the device or components thereof. The core material may be smooth or textured, fibrous or of uniform consistency. Moreover, the core material may be rigid or substantially rigid, or flexible, bendable or foldable as required by the document. The core material may be treated or modified in any way in the production of the final document. For example, the core material may be printed on, coated, impregnated, or otherwise modified in any other way.
Transmitted light: refers to light that is incident upon a surface, layer or multiple layers, of which a portion of the light is able to pass through and/or interact in some way with the surface, layer or layers by transmission. Light may be transmitted through a layer or layers by virtue of the layer or layers not being entirely opaque, but instead permitting at least a portion (e.g. 0-99%) of the incident light to be transmitted through the layer or layers in view of the layer or layers exhibiting at least some degree of translucency.
Window: refers to a region or portion of a security document in which a component of a security device is exposed for visual inspection, because there is little or no translucent or opaque material to obscure the view of the exposed portions. A window may be present even if there are transparent or translucent layers, for example of film, to cover the security device or components thereof, because the exposed portions of the security device are still visible, at least in part, through the film. In further selected embodiments as disclosed herein ‘window’ refers to one or more portions of a security device as disclosed herein in which a masking layer does not extend across the entire surface of a security device, such that portions of the security device are exposed for visual inspection in reflective light. A window may also refer to a clear or transparent or translucent region of a substrate, for example for viewing therethrough other parts of a security document when the document is folded or manipulated.

### DETAILED DESCRIPTION OF SELECTED EMBODIMENTS

Disclosed herein are optical devices that are useful for a broad range of applications. The optical devices exhibit distinct and characteristic optical properties that, at least in selected embodiments, are readily observable or detectable by a user, either by visual inspection and/or with the aid of a screening tool.

The devices are especially advantageous since, at least in selected embodiments, they achieve a perceivable, observable or detectable change in optical appearance by simple tilting of the device relative to an observer (or detection device). Therefore, such embodiments often may not require physical or chemical changes to occur in the device, nor do they require any special treatment of the device, to achieve a desired optical effect. Once manufactured, therefore, the devices are generally static, thus providing long-term stability and durability in use.

The optical changes or effects that are perceived by a user of the disclosed optical devices are somewhat unusual depending upon the embodiment. Both simple and complex optical changes may be perceivable during progressive tilting of the device by a user, ranging from a mere “flash” of a colour or image to the perception of a more complex colour-changing or moving image. The range of available embodiments, and the flexibility of the disclosed devices, will become more apparent from the foregoing.

The disclosed devices are relatively simple in nature and so can be manufactured efficiently and at relatively low cost. This is because, in their simplest form, they merely comprise a luminescent material that when stimulated produces luminescent radiation having at least a peak output wavelength in terms of the intensity of the radiation; together with an optical filter coupled to the luminescent material. The optical filter is ‘angle-dependent’ such that the luminescent radiation is transmitted through and emitted from the filter in an angle dependent manner. In this way, inspection whilst progressively tilting the device through a number of degrees causes at least one fraction of the luminescent radiation emanating from the device to be momentarily perceivable, observable or detectable external to the device. For example, the optical filter may be configured such that it selectively permits a narrow selection of wavelengths of luminescent radiation to be emitted from the device, whilst confining the emitted radiation to within a narrow range of one or more different emission angles.

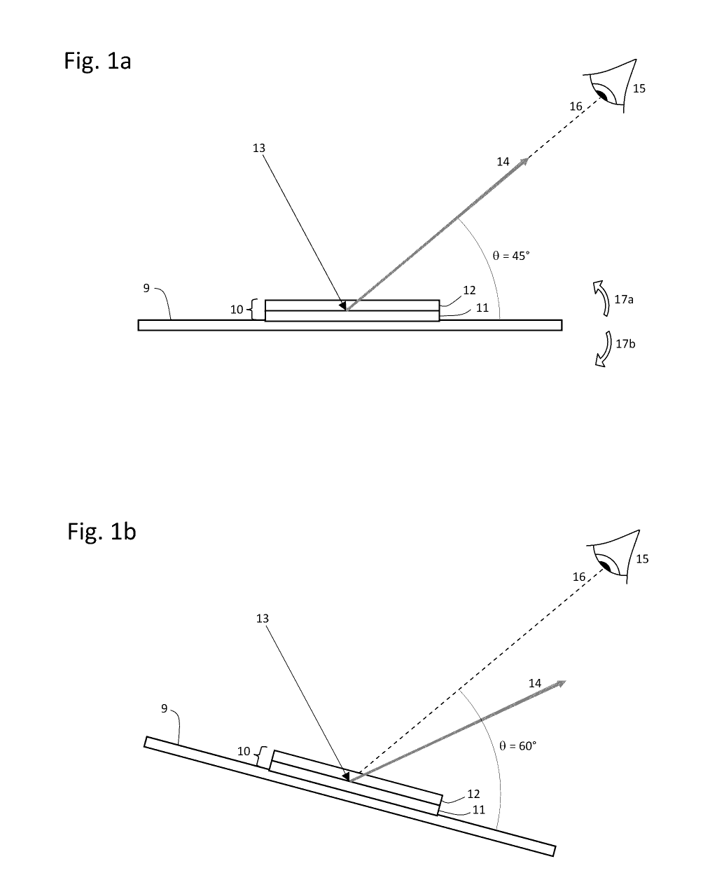

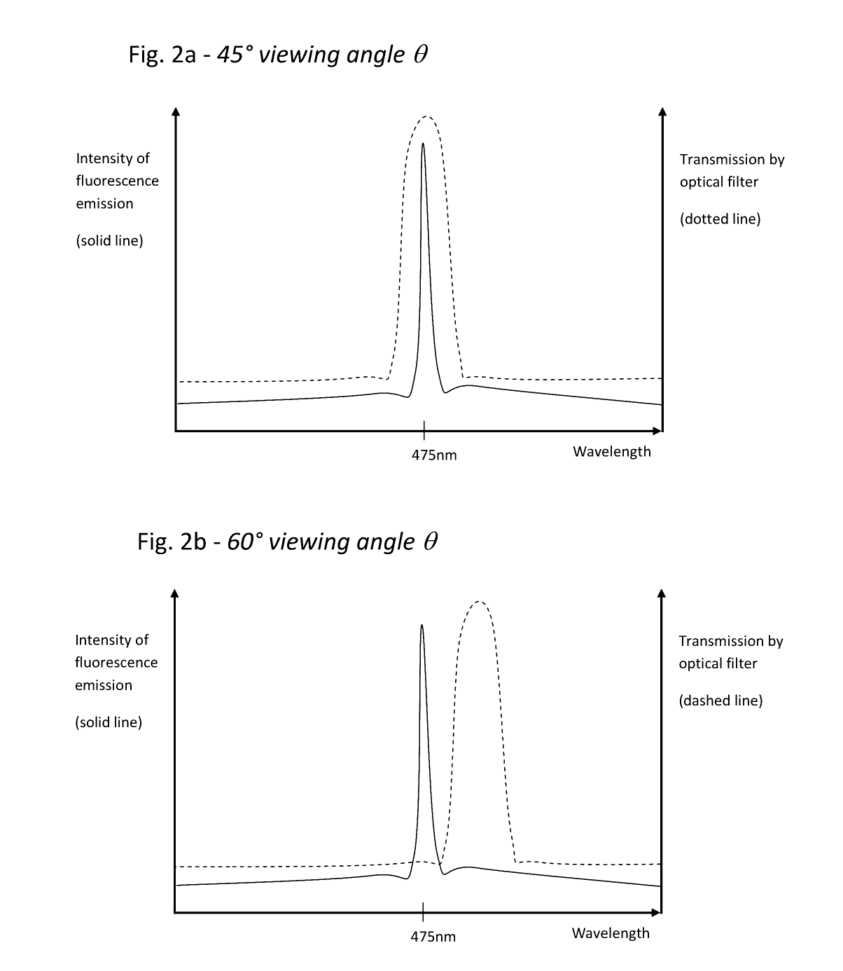

For clarity, a corresponding example embodiment will be described with reference to FIGS. 1a to 2b. In FIG. 1a there is shown, at least in schematic form, a cross-sectional view of an optical device 10 affixed to polymer substrate 9. The optical device 10 comprises a generally planar, laminate structure with two layers including a luminescent material layer 11 and optical filter layer 12. Incident light 13, which in this example comprises ultraviolet radiation, falls upon device 10 passing through optical filter 12 to stimulate luminescent material 11. Once stimulated, luminescent material 11 is caused to emit luminescent radiation 14 comprising electromagnetic radiation of a specific colour in the visible range at or close to a predetermined peak output wavelength. Since polymer substrate 9 is essentially opaque, the luminescent radiation 14 primarily exits the device by passing through optical filter 12, the properties of which are preferably matched to receive and “process” only luminescent radiation at or close to the peak output wavelength of the luminescent radiation 14 emitted by luminescent material 11.

As a result, the luminescent radiation 14 is emitted from the device at or very close to a peak output angle theta, which in the example shown in FIG. 1 is about 45 degrees relative to the plane of substrate 9. This means that an eye 15 of an observer of the device, when positioned at 45 degrees relative to substrate 9 and looking along line of sight 16, receives and can perceive or “see” the luminescent radiation 14 emitted from the device. In the example shown, however, the optical filter is very specific with regard to emission angle, so that most if not all of luminescent radiation 14 is emitted at or within 5 degrees of a peak output angle. Even slight tilting of the device by just a few degrees (see arrows 17a and 17b) results in the luminescent radiation 14 no longer being visible to the observer's eye 15, via line of sight 16.

For example, tilting of the same device relative to FIG. 1a is indicated in FIG. 1b. Here substrate 9 and device 10 are both tilted “downwards” on the right side of FIG. 1b (compared to FIG. 1a) as shown, in accordance with arrow 17b (shown in FIG. 1a), such that the angle theta of the line of sight 16 extending from the observer's eye 15 is increased from 45 degrees to 60 degrees relative to the plane of substrate 9. All other aspects of FIG. 1b, including the incident light 13 and the position of the observer's eye 15, remain unchanged over FIG. 1a. It may be noted that luminescent radiation 14 no longer enters eye 15 along line of sight 16, and so will no longer be perceivable or visible to the observer. In fact, as shown, the same would be true had the device been tilted either “up” or “down” on the right side just a few degrees compared to FIG. 1a. It will be apparent that if the device is tilted back from the position shown in FIG. 1b to the position shown in FIG. 1a, and the user continuously and progressively tilts the device in the same general direction, luminescent radiation 14 will momentarily coincide with line of sight 16 so that the radiation will momentarily enter the user's eye 15 before the tilting motion of the device moves the luminescent radiation 14 back out of alignment with line of sight 16. The impression from the device, at least from the visual perspective of the user, thus will be a momentary “flash” of colour from the device as the device is tilted and the path of the luminescent radiation 14 momentarily passes through line of sight 16 as the device is progressively tilted “upwards” on the right side (in accordance with arrow 17a in FIG. 1a). If a user stops tilting the device at an angle theta of 45 degrees, then the user will see the luminescent radiation continuously along line of sight 16, rather than a “flash”.

FIGS. 2a and 2b illustrate graphs to show schematically how the luminescent emission, and optical filtering of the emission, is affected as the device shown in FIG. 1 is tilted relative to a user's eye. FIG. 2a provides a graph for a 45 degree viewing angle theta corresponding to FIG. 1a, and FIG. 2b provides a graph for a 60 degree viewing angle theta corresponding to FIG. 1b. In each graph the x-axis represents wavelength. The y-axis of each graph represents intensity of luminescence emission 14 from the luminescent material layer 11 (solid line) as well as the degree of transmission by the optical filter (dashed line). It is notable that the luminescent material 11 generates a luminescence emission 14 that (at least in this embodiment) is a single very narrow peak, corresponding to an intense single colour with a wavelength of about 475 nm (blue). The optical filter has a transmission specificity and generally blocks the transmission of electromagnetic radiation, with the exception of a narrow selection of wavelengths that are filtered and refracted though the filter. Importantly, the wavelength of electromagnetic radiation that transmits through the filter is dependent upon emission angle, such that the filter ‘permits’ transmission of radiation at about 475 nm to be emitted from the filter at about 45 degrees (FIG. 2a), and further ‘permits’ transmission of radiation at about 525 nm to be emitted from the filter at about 60 degrees (FIG. 2b). As shown in FIG. 2a, at a 45 degree viewing angle the emission peak of the luminescent radiation and the transmission/emission peak of the optical filter effectively coincide, permitting the user to ‘see’ the luminescence radiation at this angle. However, as shown in FIG. 2b, at a 60 degree viewing angle the emission peak of the luminescent radiation and the transmission/emission peak of the optical filter do not coincide, and as a result the luminescence radiation is no longer visible to a user of the device at this viewing angle.

In effect, as shown in FIGS. 1 and 2, the optical filter coupled to the luminescent material selectively transmits and emits the luminescent radiation from the device at a peak output angle, with the majority of the luminescent radiation produced by the luminescent material emitted from the device at, or close to, the peak output angle. The narrow emission peak and the narrow transmission peak shown in FIGS. 2a and 2b, together with angle dependent emission of the luminescent radiation, enable the luminescent radiation emanating from the device to be emitted as a very narrow band of emission at a specific emission angle. This in turn gives rise to the perceivable “flash” of the emitted radiation as the device is tilted continuously and progressively relative to the user's eye, which contrasts directly to other known colour-shift devices, which typically undergo a more gradual perceived colour shift or optical change during tilting.

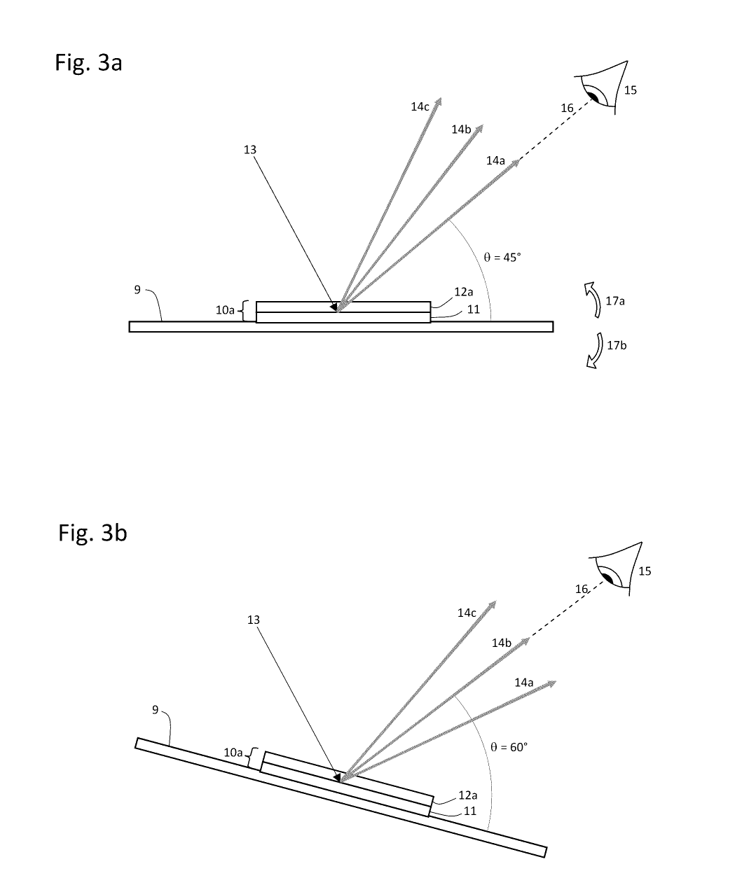

FIGS. 3a and 3b illustrate an alternative embodiment. In most respects the device 10a shown is in FIGS. 3a and 3b is identical to that shown in FIGS. 1a and 1b (and the same 45 degree and 60 degree lines of sight 16 are illustrated in FIGS. 3a and 3b respectively, between the user's eye 15 and the plane of substrate 9. However, a key difference between the device in FIG. 1 and the device in FIG. 3 relates to the optical filter 12. In FIG. 3 an alternative optical filter 12a is used, which has alternative optical properties to optical filter 12 shown in FIG. 1, as will be explained. These properties are such that optical filter 12a effectively ‘splits’ the luminescent radiation 14 generated by stimulation of the luminescent material 11 between three distinct emission angles, illustrated in FIGS. 3a and 3b as emitted luminescent radiation 14a, 14b and 14c.

Therefore in FIGS. 3a and 3b, the same incident light 13 falls upon device 10a, passing through optical filter 12a to stimulate luminescent material 11, which in turn generates the same luminescent radiation 14 as for FIGS. 1a and 1b. However, upon subsequent transmission through optical filter 12a the luminescent radiation 14 is effectively divided into three distinct and narrow angles of emission 14a, 14b and 14c, by virtue of the optical properties of the filter. In a similar manner to luminescent radiation 14 shown in FIG. 1, the majority of the luminescent radiation emanating from the device (from optical filter 12a) is emitted at, or at least very close to, each luminescent emission angle 14a, 14b, 14c, which represent peak angles of emission for the luminescent radiation emanating from the device. Outside of those peak emission angles, little or no luminescent emission occurs from the device. To a user of the device, the perceivable effect of this arrangement is three distinct “flashes” of luminescent radiation as the device is progressively tilted, such that each emission 14a, 14b, 14c momentarily intercepts line of sight 16.

In FIG. 3a luminescent radiation 14a is in line with a 45 degree angle between the plane of substrate 9 and line of sight 16, and thus luminescent radiation 14a enters the user's eye 15. As the device is progressively tilted from the position illustrated in FIG. 3a to the position illustrated in FIG. 3b, the luminescent radiation will not generally enter the user's eye 15 until luminescent radiation 14b is in line with line of sight 16 as illustrated in FIG. 3b. Continued tilting of the device through and beyond the 60 degree angle shown in FIG. 3b will result in another observable “flash” of radiation to user 15 attributable to luminescent radiation 14b. Again, as the angle further increases little or no luminescent radiation will enter the user's eye 15 until luminescent radiation 14c is in line with line of sight 16 (not shown) at which time a third and final flash of luminescent radiation will be observed by the user as the device is progressively tilted to an angle of theta of more than 75 degrees. In total, progressive tilting of the device from zero to ninety degrees for angle theta will cause three distinct “flashes” of radiation to be perceived and observed by the eye 15 of the user of the device as the device is tilted. As described previously, such “flashes” are not dynamic changes in the physical, chemical or optical properties of the device, but rather perceived as flashes by a user of the device as the emitted luminescent radiation intercepts the user's line of sight.

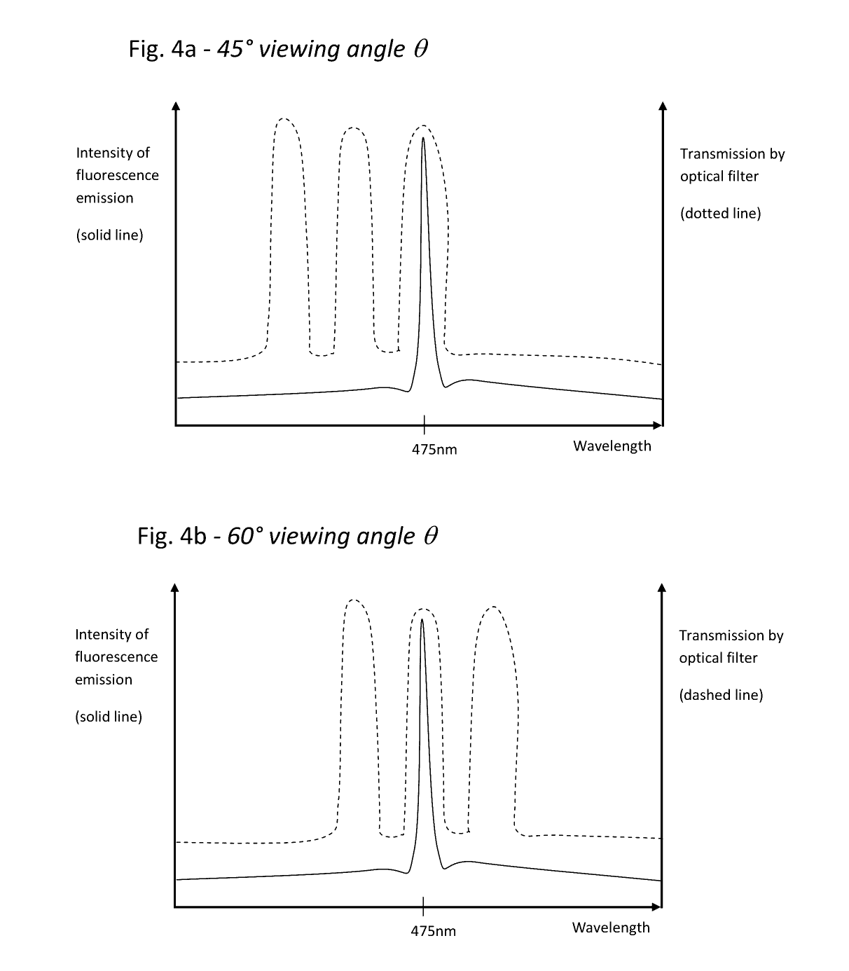

FIGS. 4a and 4b illustrate graphs similar to those shown in FIGS. 2a and 2b. However, FIGS. 4a and 4b illustrate schematically the luminescent radiation 14 of luminescent material 11, and the properties of alternative optical filter 12a. As for FIGS. 2a and 2b, FIGS. 4a and 4b provide graphs for 45 degree and 60 viewing angles for angle theta respectively. The graph showing luminescent emission 14 from luminescent material 11 (solid line) retains an identical single peak output wavelength as for FIGS. 1a and 1b at 475 nm, because the luminescent material and its luminescent properties are the same. Moreover, as for FIGS. 2a and 2b, the wavelength of the output radiation does not change with angle theta in FIGS. 4a and 4b. However, in contrast to FIGS. 2a and 2b, the graph illustrated for optical filter transmission (dotted line) in FIGS. 4a and 4b includes not one but three distinct peaks, showing that the filter permits transmission and angle dependent emission of luminescent radiation at three different wavelengths for any given viewing angle theta.

As for FIGS. 1a and 1b, by comparing FIGS. 4b to 4a it can be seen that an increase in viewing angle theta effectively shifts the optical filter transmission graph (dotted line) to reposition the transmission peaks (at which the filter permits transmission of electromagnetic radiation) to higher wavelengths. For example, FIG. 4a illustrates both the luminescent radiation graph (solid line) and optical filter transmission graph (dotted line) for a given 45 degree viewing angle theta as shown in FIG. 3a. The right hand peak in the graph for optical filter transmission is aligned at 475 nm with the graph for luminescent radiation emission (solid line) for the luminescent material. As the viewing angle theta is increased from 45 degrees to 60 degrees (as per FIG. 3b) the graph for optical filter transmission effectively shifts to the right as shown in FIG. 4b, and in doing so the middle peak in the graph for optical filter transmission (dotted line graph) is now positioned at 475 nm in line with the peak luminescent radiation (solid line graph). Although not shown, a further increase in angle theta to 75 degrees would cause a still further shift to the right for the graph for optical filter transmission (dotted line), such that the left hand peak in the graph would be positioned at 475 nm, in line with the peak luminescent radiation (solid line graph). In this way, the optical filter essentially ‘permits’ transmission of the luminescent light at 475 nm to occur at or near to the peak output angles of 45 degrees, 60 degrees, and 75 degrees for angle theta, corresponding to arrows 14a, 14b and 14c respectively in FIGS. 3a and 3b.

As for the embodiment described with reference to FIGS. 1 and 2, it may be desired in some embodiments for most of the output of the luminescent radiation to have wavelengths at or close to the peak output wavelength, thereby to provide a relatively narrow peak for the graph of luminescence intensity (solid line in FIGS. 4a and 4b). Furthermore, it may be desired in some embodiments for the peaks in the optical filter transmission graph (dotted line in FIGS. 4a and 4b), which define wavelengths at which the optical filter permits transmission of light, to be relatively narrow. In this way, the large majority of the luminescent output of the device is focused into a narrow range of output angles, at or very close to the peak output angles corresponding to 14a, 14b, 14c shown in FIGS. 3a and 3b, which in turn gives rise to more sharply defined “flashes” of luminescent radiation perceived by a user of the device as the device is progressively tilted, and angle theta is increased or decreased.

For example, in some embodiments, the optical filter may be suitable to cause at least 70% of the luminescent radiation derived from the luminescent material of the device to be emitted at, or within 15 degrees from, one or more peak output angles from the device, such that the luminescent radiation emitted from the device is momentarily observable or detectable at different peak output angles as the device is progressively tilted.

For example, in further embodiments, the optical filter may be suitable to cause at least 80% of the luminescent radiation derived from the luminescent material of the device to be emitted at, or within 10 degrees from, two or more peak output angles from the device, with fractions of the luminescent radiation emitted from the device momentarily observable or detectable at different output angles as the device is progressively tilted.

For example, in further embodiments, the optical filter may be suitable to cause at least 90% of the luminescent radiation derived from the luminescent material of the device to be emitted at, or within 5 degrees from, two or more peak output angles from the device, with fractions of the luminescent radiation emitted from the device momentarily observable or detectable at different output angles as the device is progressively tilted.

In other embodiments, the fractions of the luminescent radiation emitted from the device (that are momentarily observable or detectable at different output angles as the device is progressively tilted) may depend in part upon the nature of the luminescent radiation generated by the luminescent material. For example, in some embodiments at least 70 percent of the luminescent radiation from the luminescent material may have a wavelength at, or within 50 nm of, a peak output wavelength. In other embodiments at least 80 percent of the luminescent radiation from the luminescent material may have a wavelength at, or within 25 nm of, a peak output wavelength. In further embodiments at least 90 percent of the luminescent radiation from the luminescent material may have a wavelength at, or within 10 nm of, a peak output wavelength from the luminescent material. With increasing degrees, therefore, the “narrowness” and intensity of the peak wavelengths of luminescent radiation generated by the luminescent material (e.g. see graph with solid line in FIGS. 2a, 2b, 4a, 4b) can help define the observable flash or flashes of luminescent radiation as perceived from the perspective of the user. In other examples, the luminescent material may emit luminescent radiation with a full wave half maximum (FWHM) of 50 nm or less, 25 nm or less, or 10 nm or less depending upon the embodiment, and the luminescent material being employed.

The graphs for optical filter transmission shown in FIGS. 4a and 4b (dotted lines) each include three peaks corresponding to wavelengths at which the optical filter “permits” transmission of luminescent light therethrough, for any given viewing angle. As discussed, narrower transmission peaks correspond to more brief “flashes” of observable electromagnetic radiation as the device is progressively tilted by a user. In FIGS. 4a and 4b (and other figures) the transmission peaks (dotted lines) are shown to have a similar width and shape when compared to one another. For this reason, progressive tilting of the device at a constant rate of tilt causes three corresponding flashes to be perceived by a user, with the flashes having similar flash durations. However, yet further embodiments include the use of alternative optical filters that exhibit optical transmission graphs with multiple peaks (in a similar manner to FIGS. 4a and 4b) but wherein the peaks have different widths relative to one another. Indeed, optical filters may be custom designed in this manner, as required for any particular optical device. In this way, as the device is progressively tilted at a constant rate of tilt, the “flashes” of luminescent radiation that are apparent to the user may intercept the users line of sight for different time periods. A longer “flash” typically corresponds to a wider range of angles of emission of a particular portion or fraction of the luminescent radiation emanating from the device, which in turn corresponds to a wider peak within the optical transmission graph for the optical filter. In contrast, a shorter “flash” typically corresponds to a narrower range of angles of emission for a particular portion or fraction of the luminescent radiation emanating from the device, which in turn corresponds to a narrower peak within the optical transmission graph for the optical filter. Further embodiments of the devices include optical filters that achieve different length-of-time flashes for one or more different wavelengths of luminescent radiation, as the devices are progressively tilted at a constant rate.

Any luminescent material may be used in accordance with the devices herein disclosed. The luminescent material may be stimulated by any appropriate source of incident radiation suitable to cause the luminescent material to luminesce by emission of electromagnetic radiation of a wavelength that is different to the incident radiation. For example the luminescent material may be of a type that is stimulated to produce luminescent radiation in the visible spectrum subsequent stimulation by incident ultraviolet light. This type of luminescent material may present certain advantages because the luminescent optical effect would be observable only with the use of a screening device or tool that produces incident UV radiation, and yet the output would be visible to a user in the visible spectrum. Moreover, UV light sources are widely available and accepted technology for document screening.

The optical filter used in accordance with the devices herein disclosed may take any form or structure suitable to cause angle-dependent filtering of any form of luminescent radiation. More specifically, at least in selected embodiments, the optical filter may process the received luminescent radiation, so as to cause the luminescent radiation to be transmitted and emitted in an angle-dependent manner at or very close to one or more than one peak output angles. Such optical filters, and their optical transmission properties, may be custom-designed according to the nature of the luminescent radiation to be received and filtered, as well as the type of angle and wavelength-dependent filtering required for the specific embodiment. Optical filters may selected from, but are not limited to, optical interference structures such as a Fabry Perot structures, Bragg stacks, or thin-film filters or foils.

Any optical filter may filter incident radiation upon the optical device and/or luminescent radiation emitted from the device. In some embodiments described herein an optical filter is employed and described for angle dependent filtering of luminescent radiation emitted from luminescent material of the device. However, in other embodiments the optical filter may cause optical filtering, such as but not limited to angle dependent filtering, to the indicident radiation upon the optical device. Such optical filtering of incident radiation (before or without stimulation of the luminescent material) may provide further variants to the present optical devices.

Any optical filter as described herein, for use with any corresponding optical device, may have uniform optical filtering properties, and a substantially uniform form or structure, across an area of the filter. In some selected embodiments, however, the optical filter may have non-uniform filtering properties, such that different optical filtering occurs for example in one area of the device compared to another. For example, the optical filtering properties may be dependent upon the thicknesses or optical properties of the layer or layers that make up the optical filter. If a spacer layer is required, such as for a Fabry Perot optical structure, the thickness of the spacer layer may vary progressively or markedly according to the region of the device, and a desired pattern of optical effects. Other foils may have different thicknesses or different optical densities in different regions or areas of the device, such that luminescent radiation is caused to be emitted from the device at different angles or degrees according to the optical filter. The devices as described are not limited with regard to the optical filters, and the manner in which they influence luminescent radiation in a uniform or non-unform manner.

Depending upon the device, the output of the luminescent material and the transmission of the optical filter may be ‘matched’. An optical filter may be chosen or designed, which specifically filters (in an angle-dependent manner) radiation of a wavelength corresponding to the peak output wavelength of the luminescent radiation. For example, if the luminescent material is known to generate luminescent radiation with a peak output wavelength of 460nm, then the optical filter may be chosen or designed to transmit light selectively at between 440 nm and 480 nm at specific output angles.

Still further embodiments may comprise a luminescent material or layer that when stimulated emits luminescent radiation of more than one wavelength. Such luminescent materials may, for example, comprise two or more different luminescent substances in admixture. Alternatively such luminescent materials may comprise discrete areas or layers of different luminescent substances that appear to luminesce at different wavelengths from different, the same, or overlapping areas of the device.

Such luminescent materials, when stimulated, may produce luminescent radiation of more than one different peak output wavelength, for subsequent angle-dependent filtering by the optical filter. The optical filter in turn may transmit and emit luminescent radiations of different peak output wavelengths in the same manner, such that they are emitted from the device at the same angles and in the same way. Alternatively, the luminescent radiation of one wavelength may be emitted from the device at one or more peak output angles that are different from the peak output angles of luminescent radiation of at least one other wavelength. In this way, different fractions of the luminescent radiation with different colours or wavelengths may be emitted from the device at different angles such that they are observed by a user of the devices as “flashes” of different colours as the device is progressively tilted relative to the user/observer. Various embodiments therefore encompass devices that produce more than one wavelength of luminescent radiation, wherein the associated optical filters are designed to separate and/or blend the different colours produced at various output angles.

Therefore, in selected embodiments the devices may comprise more than one type of luminescent material, each producing when stimulated luminescent radiation of a peak output wavelength that is different to the other types of luminescent material(s) present, so that the device produces luminescent radiation of more than one peak output wavelength. The optical filter then filters the resulting luminescent radiation in a angle-dependent manner, the luminescent radiation of one wavelength being emitted from the device at one or more peak output angles that are the same or different from the peak output angles of luminescent radiation of at least one other wavelength. In this way, different fractions of the luminescent radiation emitted from the device with different colours or wavelengths may be momentarily observable or detectable as the device is progressively tilted.

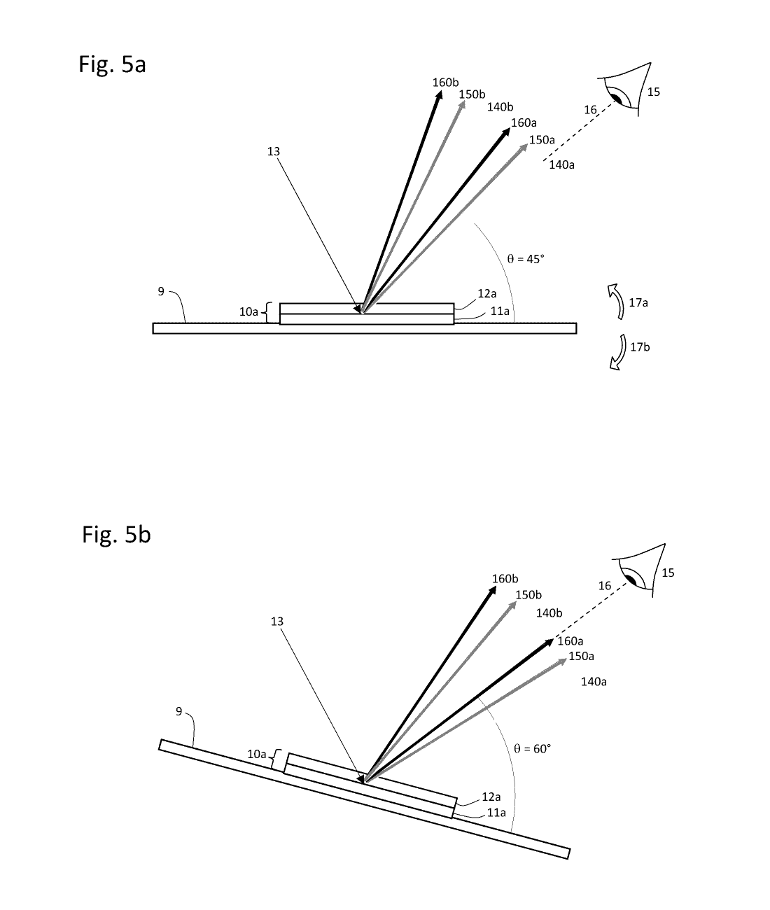

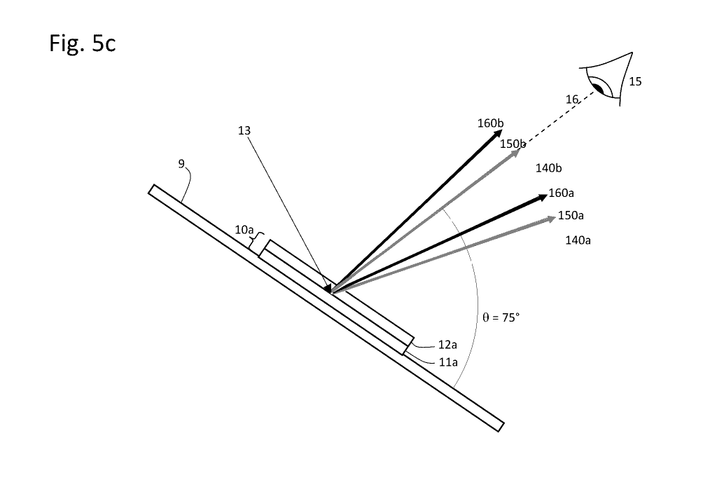

FIGS. 5a, 5b, and 5c illustrate an exemplary embodiment of a device 10a that employs a luminescent material 11a that, by virtue of a blend of luminescent substances present, produces when stimulated combined luminescent radiations with three different peak output wavelengths or colours at 550 nm, 580 nm and 605 nm (or green, yellow and orange respectively). Depending upon the structure or configuration of the luminescent material, the different colours may be emitted from the same or different areas of the device as required.

Therefore, as shown in FIGS. 5a to 5c, the same incident light 13 falls upon device 10a, passing through optical filter 12a to stimulate luminescent material 11a, which in turn luminesces to generate luminescent radiation of three different colours: green, yellow and orange. Optical filter 12a filters the luminescent radiation of three different colours permitting emission of each colour from the device in angle-dependent manner. In FIG. 5a it can be seen that green luminescent radiation is emitted as arrows 140a and 140b, yellow luminescent radiation is emitted as arrows 150a and 150b, and orange luminescent radiation is emitted as arrows 160a and 160b, from the device. As before, each luminescent radiation of 140a, 140b, 150a, 150b, 160a and 160b represents luminescent radiation emitted from device 10a at or close to specific peak emission angles. As a result, progressive tilting of the device by a user will result in perception of multiple flashes of different colours of luminescent radiation from the device.

In FIG. 5a an angle theta of 45 degrees from the line of sight 16 (from eye 15) to a plane of the substrate 9 causes eye 15 to see green fluorescent emission 140a from the device. In FIG. 5b the device has been progressively tilted (as per arrow 17b in FIG. 5a) such that angle theta has increased from 45 to 60 degrees. In doing so the user will see a brief flash of yellow as yellow fluorescent emission 150a passes though the line of sight 16 before angle theta reaches 60 degrees as shown in FIG. 5b, at which moment a user will see orange luminescent radiation 160a along line of sight 16. In FIG. 5c the device has been progressively tilted yet further (as per arrow 17b in FIG. 5a) such that angle theta has further increased from 60 to 75 degrees. In doing so the user sees a brief flash of green as green fluorescent emission 140b passes though the line of sight 16 before angle theta reaches 75 degrees as shown in FIG. 5c, at which moment a user will see yellow luminescent radiation 150b along line of sight 16. So it may be seen that a user progressively tilting device 10a, such that angle theta increases from zero to ninety degrees will observe momentary flashes of emitted luminescent radiation from the device that are green, yellow, orange, green, yellow and again orange. If a user stops tilting the device at any angle that corresponds to emission 140a, 140b, 140c, 150a, 150b, 150c, 160a, 160b or 160c then the user will see a corresponding steady or continuous emission colour along line of sight 16.

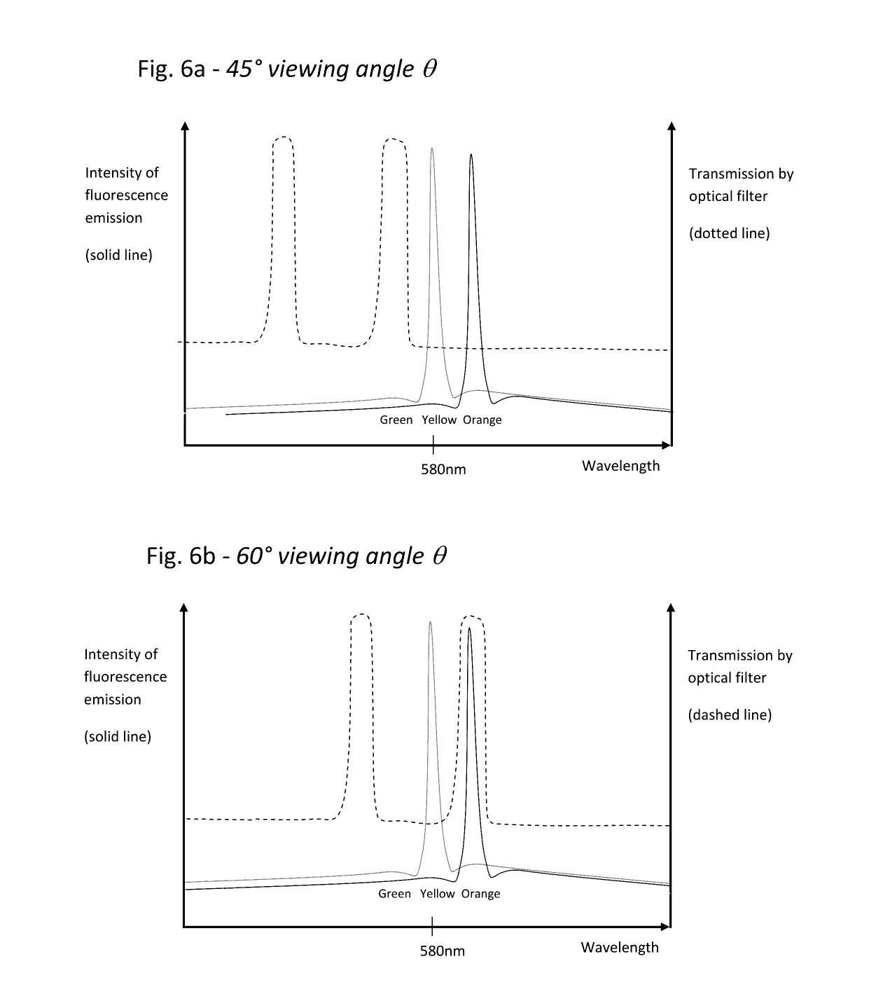

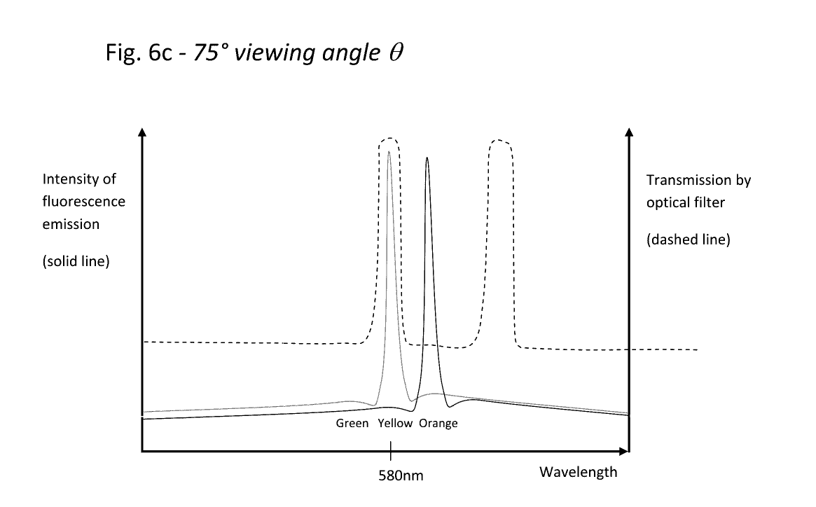

In a manner similar to previous figures, FIGS. 6a, 6b and 6c provide a graphical representation of FIGS. 5a, 5b and 5c respectively. In each of FIGS. 6a, 6b and 6c three peaks of luminescence intensity are shown for the luminescent radiation 140, 150, 160 shown in FIG. 5. The left hand peak is labeled “green” (arrows 140 shown in FIG. 5), the middle peak is labeled “yellow” (arrows 150 in FIG. 5), and the right hand peak is labeled “orange” (arrows 160 in FIG. 5). As before, the graph for optical transmission by optical filter 12a is shown as a dotted line, which in this embodiment includes two “peaks” indicative of increased transmission at specific wavelengths, wherein the optical filter essentially “permits” transmission of light therethrough for any given angle theta. The two peaks essentially cause each colour of the luminescence radiation 140, 150 and 160 to be split into luminescent radiation emergent from the device at two different angles for each wavelength, corresponding to 140a and 140b, or 150a and 150b, or 160a and 160b, respectively.

In FIG. 6a, which corresponds to an angle theta of 45 degrees as per FIG. 5a, the right hand peak in the graph for optical filter transmission is in alignment with the peak for green luminescence such that a user's eye 15 views the green emission 140a along line of sight 16 in FIG. 5a. As the device is tilted along arrow 17b (shown in FIG. 5a) the optical filter transmission graph essentially shifts to the right, such that with increasing angles of theta the optical filter permits transmission therethrough of increasingly higher wavelengths of radiation. Therefore, as shown in FIG. 6b, with an angle theta of 60 degrees the right hand peak in the graph for optical filter transmission (dotted line) is in alignment with the peak for orange luminescent radiation, such that user 15 can look along line of sight 16 and view orange luminescent radiation 160a (see FIG. 5b). Further, as shown in FIG. 6c, with an angle theta of 75 degrees the left hand peak in the graph for optical filter transmission is in alignment with the peak for yellow luminescent radiation, such that user 15 can look along line of sight 16 and view yellow luminescent radiation 150b (see FIG. 5c).

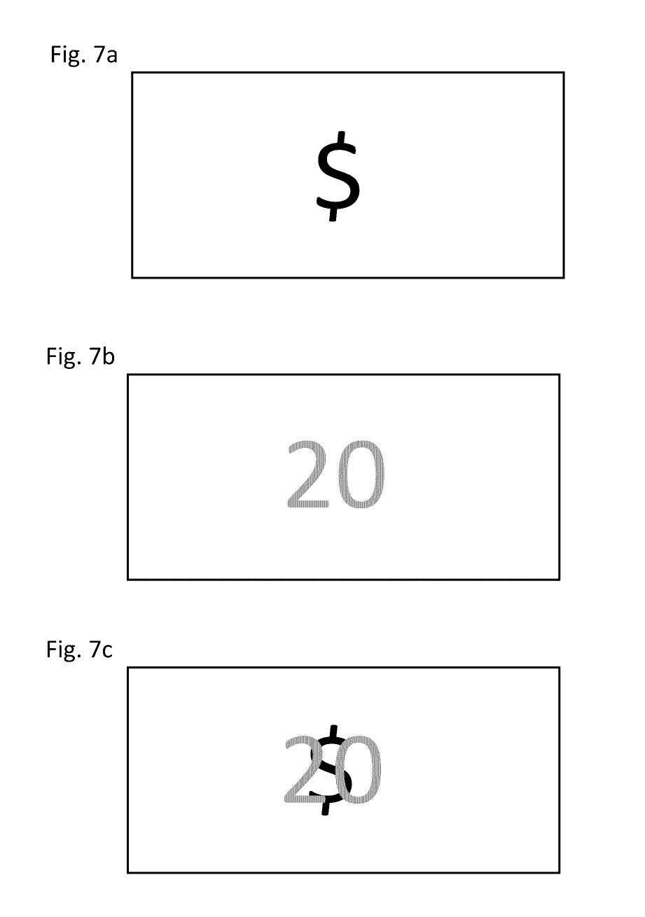

In yet further embodiments, a device may be produced that presents different luminescent images to a user of the device depending upon the angle theta at which the device is held by the user. For example, in FIG. 7a there is shown a device that, for a first angle theta, a dollar sign is observed having a luminescent wavelength of 525 nm (blue). However, FIG. 7b shows the same device as FIG. 7a but when observed at a second angle theta that is different from the first angle theta, such that the dollar sign is no longer observable at the particular viewing angle, and instead a number “20” is observed having a luminescent wavelength of 675 nm (red). As illustrated, the number “20” is located in the same area or at an overlapping position of the device compared to the blue dollar sign. However, in other embodiments the different images may be located at the same, a different or overlapping locations or areas of the device. In select embodiments, the optical filter may be such that at some angles theta the blue and red images may be emitted together at the same angle thus giving a blended image as shown in FIG. 7c.

In yet further embodiments, the devices may include more complex arrangements of luminescent materials and more complex filters, such that perceived moving images are possible as the user progressively tilts the device from a first angle theta to a second angle theta, wherein the moving images may comprise multiple different images viewed at different angles optionally using different wavelengths of fluorescence emission from the device.

The embodiments thus far have described and explained devices that, at least from the perception of a user progressively tilting the device, exhibit brief “flashes” of luminescent radiation corresponding to the interception of narrow bands of radiation emitted from the device at specific angles momentarily within the user's line of sight. Such devices may be collectively termed “flash-on” devices because at most emission angles theta they appear to a user to be primarily “dark” in that no emitted radiation can be observed by a user, and yet as they are progressively tilted brief “flashes” of emitted radiation are observed. In still further contrasting embodiments, “flash-off” devices may also be generated, in which a user can detect or see emitted luminescent radiation at most emission angles theta, and yet at specific angles theta the device does not appear, at least from the perspective of the user, to emit any luminescent radiation. In other words, an opposite effect to the previously described embodiments may be achieved, in which brief “flashes off” are observed as the device is progressively tilted.

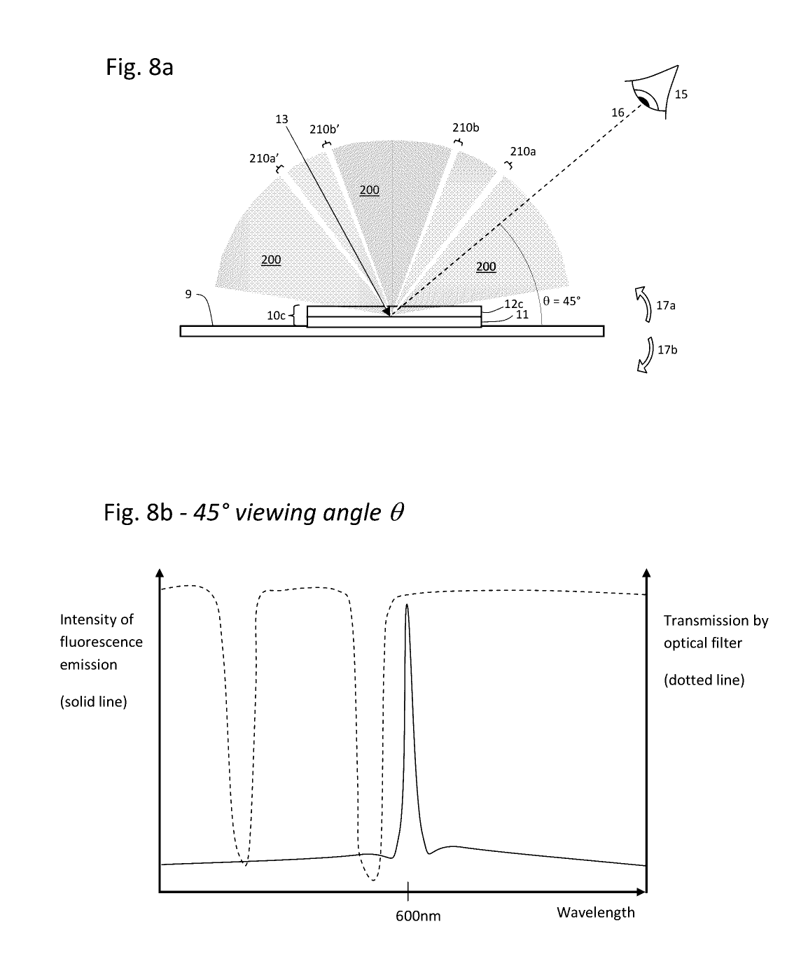

An example “flash off” device is described with reference to FIGS. 8a and 8b. In FIG. 8a the device 10c is shown in cross section upon substrate 9, with luminescent material 11 and optical filter 12c. Incident radiation 13 stimulates luminescent material 11, which generates luminescent radiation. This luminescent radiation is filtered by optical filter 12c in an angle-dependent manner, but rather than being emitted from the device in one or more narrow bands of emitted radiation as before, the optical filter is such that the luminescent radiation is emitted at all angles 200 with two notable exceptions for dark angles 210a and 210b (FIG. 8a also shows the additional fluorescent emission from the device as a ‘mirror’ of emission from the normal from the device, with corresponding dark angles 210a′ and 210b′; see below). When the angle theta is increased by progressively tilting the device in direction 17b the user's eye 15 can detect luminescent radiation 200 at most angles theta, except for when angle theta is such that line of sight 16 co-incides or aligns with dark angles 210a and 210b: at these viewing angles the device (at least from the perception of the user) appears to “flash-off” briefly before the user once again sees or detects luminescent radiation 200 at a further increased angle of theta as the device is progressively tilted relative to the user. If a user stops tilting the device at either of dark angles 210a and 210b, then the user will continuously see little or no luminescent radiation along line of sight 16.

FIG. 8b graphically illustrates the luminescent radiation and optical filtering of the device illustrated in FIG. 8a. It may be seen that the device generates luminescent radiation of just one wavelength (solid line) at 600 nm. The optical filter transmission, (dotted line) is such that the optical filter transmits the luminescent radiation at most angles theta, except for two specific angles theta corresponding to dark angles 210a and 210b in FIG. 8a. As angle theta progressively increases (not shown) the two narrow troughs of the graph for optical filter transmission (dotted line) briefly align themselves with the peak luminescence intensity for the luminescent radiation, giving rise to two perceived “flashes-off” as the device is progressively tilted.

For greater certainty, the described optical properties and perceived visual appearance of any optical device described herein may relate to the entirety of the device, or alternatively may relate to any portion of the device at any given time or viewing angle. For example, in relation to the “flash-off” devices described above, depending upon the size and situation of the optical device (including the nature of incident light), only a portion of the device may appear to “flash-off” as the device is tilted, whilst other options of the device may continue to appear to emit luminescent radiation. As the device is tilted, the portions of the device that appear to “flash-off” may change according to viewing angle. For example, as the device is tilted a dark region or stripe may appear to ‘scroll’ across the device, wherein the viewing angle of the dark portions of the device coinciding with an emission angle at which the luminescent radiation is essentially blocked by the optical filter. Likewise, for “flash-on” devices, the portions of the device that appear to “flash-on” may also vary with viewing angle such that a flash of colour or luminescent radiation may appear to move or scroll across the device as the device is progressively tilted.

In yet further embodiments, a device may include both flash-on and flash-off properties in combination, wherein the flash-on and flash-off may or may not overlap. For example, a device may comprise a luminescent material that generates two wavelengths of luminescent radiation (e.g. red and green). The green radiation may be filtered in a flash-on manner, such that brief flashes of green luminescent radiation are observable to a user as the device is progressively tilted. Simultaneously, the red luminescent radiation may be filtered in a flash-off manner, such that for each angle theta, when the green luminescent radiation is visible, the red luminescent radiation is not visible to a user, and when the red luminescent radiation is visible to a user, the green luminescent radiation is not visible. As this device is progressively tilted it will appear to luminesce predominantly red, and the red will appear from the user's perspective to be replaced briefly with green only at specific angles of theta.

In further embodiments there is provided a use of any optical device disclosed herein, to provide authentication to a security item or document. The optical device may be secured, integrated or adhered to the substrate of the security item or document in any way. In select embodiments, the security document may be a banknote, the optical device providing authentication as a security feature to the bank note.

Therefore, in further exemplary embodiments there is provided a security item or document, comprising a substrate with any optical device as herein described affixed, integrated or adhered thereto. In select embodiments, the security document may be a banknote, the optical device providing an authentication or security feature to the bank note.

Further exemplary embodiments also provide a method for determining whether a security device or document is a legitimate or counterfeit device or document, the item or document comprising any optical device as herein described, the method comprising the steps of: illuminating the optical device with radiation of a wavelength suitable to stimulate the luminescent material or materials present; progressively tilting the item or document whilst the device emits luminescent radiation; and observing or detecting at least one fraction of said luminescent radiation emitted from the device. The step of progressive tilting may be performed manually, or with the assistance of a screening tool that may, for example, also provide the source of incident radiation for stimulation of the luminescent material. Further, in certain exemplary embodiments a predetermined pattern of detected (by a detection device) or observed (by a user inspecting the device) fractions of luminescent radiation as the device is progressively tilted is indicative that the device is legitimate and not counterfeit.

In alternative exemplary methods, a plurality of sensors is used obviating the need for tilting of the optical device. For example, other exemplary embodiments provide a method for determining whether a security device or document is a legitimate or counterfeit device or document, the item or document comprising any optical device as described herein, the method comprising the steps of: illuminating the optical device with radiation of a wavelength suitable to stimulate the luminescent material or materials present; positioning a plurality of sensors at a plurality of positions or angles relative to the optical device whilst the optical device emits luminescent radiation; and detecting with said sensors at least one fraction of said luminescent radiation emitted from the optical device. Such methods may further comprise one or more of the following optional steps: calculating and optionally displaying the detected output angles for the luminescent radiation from the device, and optionally comparing the detected output angles with predetermined output angles known to correlate with legitimate or non-counterfeit optical devices. Such methods may be useful, for example, in bank note sorting machines in which banknotes are rapidly checked for authentication, either whilst the banknotes are stationary or moving through the sorting machine.

Other exemplary embodiments provide for a method for improving the security of an item or document, to help prevent counterfeit thereof, the method comprising: adhering or affixing any optical device as herein described to the item or document. In certain such embodiments the item or document is a banknote.

In still further exemplary embodiments there is provided an authentication device, to test whether an item or document (that appears to comprise any optical device as described herein) is legitimate or counterfeit, the authentication device comprising:
optionally a holder to hold the item or document being tested;
a source of electromagnetic radiation suitable to stimulate the luminescent material of the optical device; and
one or more sensors to gather information regarding angles of emission of luminescent radiation from the device;
optionally movement means to move the one or more sensors and the item or document relative to one another, to enable the one or more sensors to scan for different angles of emission of luminescent radiation from the device;
a comparison component to compare sensed angles of emission of luminescent radiation from the optical device with predetermined angles of emission known to be indicative of an authentic optical device, and therefore indicative an authentic item or document comprising the optical device.

Optionally the authentication device may further comprise an output component to provide a visual or electronic signal indicative of whether the item or document comprising the optical device is authentic or counterfeit.

Optionally, the authentication device may comprise a plurality of sensors, each to detect luminescent radiation emitted at a different emission angles from the device so that the plurality of sensors gather information regarding angles of emission of luminescent radiation from the device without necessarily needing to move the sensors and the item or document relative to one another.

Whilst the figures illustrate schematically various light paths and beams by way of certain arrows of both incident and emitted radiation, the embodiments illustrated are schematic and are not limited in this regard. For example, depending upon the optical filter, the emitted luminescent radiation illustrated at a certain angle theta may occur at all angles of theta from the plane of the device, and not just from the angle theta shown in the cross-sectional illustration of the device. In other words, emitted luminescent radiation shown by a single arrow in a figure may in fact occur, at least in selected embodiments, as a “cone” of radiation having an axis of symmetry corresponding to the normal of the device (the normal being a 90 degree angle of theta from a plane of the device). Therefore, the cross-sectional views of the device could also illustrate additional beams or paths of luminescent radiation, identical to those shown but mirrored from the normal (90 degree angle of theta). For selected illustrations, these additional beams or paths have been omitted for ease and simplicity of illustration and explanation. One exception is FIG. 8a, in which luminescent emission symmetry is shown about the normal from the device.

Whilst various embodiments are disclosed and explained herein they are exemplary and merely illustrative. Further embodiments not specifically described are intended to be encompassed within the scope of the present disclosure. The embodiments disclosed and explained herein are thus in no way intended to limit the scope of the appended claims.

1. An optical device comprising:
a luminescent material that upon stimulation emits luminescent radiation of at least one peak output wavelength; and
an angle-dependent optical filter coupled to the luminescent material, the luminescent radiation transmitted through and emitted from the filter in an angle dependent manner, such that inspection whilst progressively tilting the device causes at least one colour or at least one fraction of the luminescent radiation emanating from at least one portion of the device to be momentarily observable or detectable external to the device from at least one, or at least two, different viewing angles.

2. The optical device of claim 1, wherein the optical filter coupled to the luminescent material selectively emits the luminescent radiation from the device at one or more peak output angles, with at least 70% of the luminescent radiation produced by the luminescent material emitted from the device at, or within 15 degrees from, the one or more peak output angles.

3. The optical device of claim 2, wherein the optical filter causes at least 80% of the luminescent radiation to be emitted from the device at, or within 10 degrees from, two or more peak output angles, with fractions of the luminescent radiation emitted from the device momentarily observable or detectable at different output angles as the device is progressively tilted.

4. The optical device of claim 2, wherein the optical filter causes at least 90% of the luminescent radiation to be emitted at, or within 5 degrees from, three or more peak output angles, with three or more fractions of the luminescent radiation emitted from the device momentarily observable or detectable at different output angles as the device is progressively tilted.

5. The optical device of claim 1, wherein the luminescent material emits luminescent radiation with a full wave half maximum (FWHM) of 50 nm or less, 25 nm or less, or 10 nm or less.

6. The optical device of claim 1, wherein the luminescent material is stimulated to produce luminescent radiation by incident ultraviolet light.

7. The optical device of claim 1, wherein the optical filter comprises an optical interference structure, such as a Fabry Perot structure, a Bragg stack, or thin-film filter or foil.

8. The optical device of claim 1, wherein the luminescent material and the optical filter are matched in terms of the specificity of the optical filter to filter radiation of a wavelength corresponding to the at least one peak output wavelength(s) of the luminescent radiation, in an angle-dependent manner for output from the device.

9. The optical device of claim 1, wherein the luminescent material, when stimulated, produces luminescent radiation of more than one peak output wavelength for angle-dependent filtering by the optical filter, the luminescent radiation of one wavelength emitted from the device at one or more peak output angles that are the same or different from the peak output angles of luminescent radiation of at least one other wavelength, with different fractions of the luminescent radiation emitted from the device with different colours or wavelengths momentarily observable or detectable as the device is progressively tilted.

10. The optical device of claim 1, wherein the device comprises more than one type of luminescent material, each producing when stimulated luminescent radiation of a peak output wavelength that is different to the other types of luminescent material(s) present, so that the device produces luminescent radiation of more than one peak output wavelength, for angle-dependent filtering by the optical filter, the luminescent radiation of one wavelength emitted from the device at one or more peak output angles that are different from the peak output angles of luminescent radiation of at least one other wavelength, so that different fractions of the luminescent radiation emitted from the device with different colours or wavelengths are momentarily observable or detectable as the device is progressively tilted.

11. An optical device comprising:
a luminescent material that upon stimulation emits luminescent radiation of at least one peak output wavelength; and
an angle-dependent optical filter coupled to the luminescent material, at least a portion of the luminescent radiation transmitted through and emitted from the filter in an angle dependent manner at most but not all angles from the device, such that inspection whilst progressively tilting the device causes the luminescent radiation emanating from at least one portion of the device to be momentarily not observable or detectable external to the device at certain viewing angles determined by the optical filter design.

12-25. (canceled)
